(19) United States
(12) Patent Application Publication
(10) Pub. No.: US 2013/0091858 A1
(43) Pub. Date: Apr. 18, 2013

(54) EFFUSION COOLED NOZZLE AND RELATED METHOD

(71) Applicants: Anand Prafulchandra DESAI, Bangalore (IN); Nitin Subramanya SARJA, Bangalore (IN); Bhaskara Rao ATCHUTA, Bangalore (IN); Ravi Kumar KOYYANA, Bangalore (IN)

(72) Inventors: Anand Prafulchandra DESAI, Bangalore (IN); Nitin Subramanya SARJA, Bangalore (IN); Bhaskara Rao ATCHUTA, Bangalore (IN); Ravi Kumar KOYYANA, Bangalore (IN)

(73) Assignee: GENERAL ELECTRIC COMPANY, Schenectady, NY (US)

(21) Appl. No.: 13/273,490

(22) Filed: Oct. 14, 2011

(51) Int. Cl. F02C 7/18; F02C 6/08

(52) U.S. Cl. 60/782; 60/806; 60/785

(57) ABSTRACT

A fuel nozzle for a turbine combustor includes a nozzle head configured to supply a fuel/air mixture to a burner tube attached to said nozzle head and extending downstream of the nozzle head. The burner tube is provided with plural holes for introducing a fluid into the burner tube to thereby treat (e.g., cool) an interior wall of the burner tube by effusion.

### BACKGROUND OF THE INVENTION

This invention relates to turbine combustor nozzles and specifically, in one exemplary embodiment, to an effusion-cooled burner tube.

In certain known combustor designs, a burner tube is connected to the outlet or downstream end of a nozzle head and forms a fuel preparation chamber for a fuel/air mixture introduced into the burner tube from the nozzle head. Typically, the burner tube is surrounded by an impingement cup formed with a plurality of cooling holes or apertures by which compressor discharge air may be introduced into an annular space between the impingement cup and the burner tube, to thereby impingement cool the tube. The impingement cooling air may be routed to mix with fuel at the fuel nozzle head, or to mix with the fuel/air mixture downstream of the burner tube as the mixture enters the combustion chamber.

There remains a need, however, for better utilization of the cooling air used to cool the burner tube.

### BRIEF DESCRIPTION OF THE INVENTION

In accordance with a first exemplary but nonlimiting aspect, the invention provides a fuel nozzle for a combustor comprising a nozzle head configured to supply a fuel/air mixture to a burner tube attached to the nozzle head and extending downstream of the nozzle head; the burner tube provided with cooling holes for introducing a fluid into the burner tube to thereby treat (e.g. cool) an interior wall of the burner tube by effusion.

In accordance with another exemplary but nonlimiting aspect, there is provided a nozzle for a gas turbine comprising a nozzle head formed with plural fuel orifices at an aft end; a burner tube attached to the aft end of the nozzle head and extending downstream of the plural fuel orifices; a swirler arranged about the aft end of the nozzle head, adapted to introduce air for mixing with fuel exiting the plural fuel orifices; the burner tube provided with plural cooling holes downstream of the swirler for introducing cooling air into the burner tube, wherein the plural cooling holes are arranged in axially-spaced, circumferentially extending rows about the burner tube, and slanted in a downstream direction.

In accordance with still another exemplary embodiment, there is provided a method of effusion treating a burner tube in a turbine combustor comprising a locating a burner tube at an outlet end of a fuel nozzle, adapted to receive a fuel/air mixture; providing plural holes about the burner tube and introducing a fluid into the burner tube through the plural holes; and slanting the plural holes in a downstream direction at an angle sufficient to direct the fluid along an interior surface of the burner tube.

The invention will now be described in detail in connection with the drawings identified below.

### BRIEF DESCRIPTION OF THE DRAWINGS

FIG. 1 is a cross section of a known turbine fuel nozzle head and burner tube;

FIG. 2 is a cross section of a turbine fuel nozzle head and burner tube in accordance with an exemplary but nonlimiting embodiment of the invention; and

FIG. 3 is a schematic diagram of a gas turbine plant illustrating the location of the fuel nozzle shown in FIGS. 1 and 2 in one exemplary but nonlimiting embodiment.

### DETAILED DESCRIPTION OF THE INVENTION

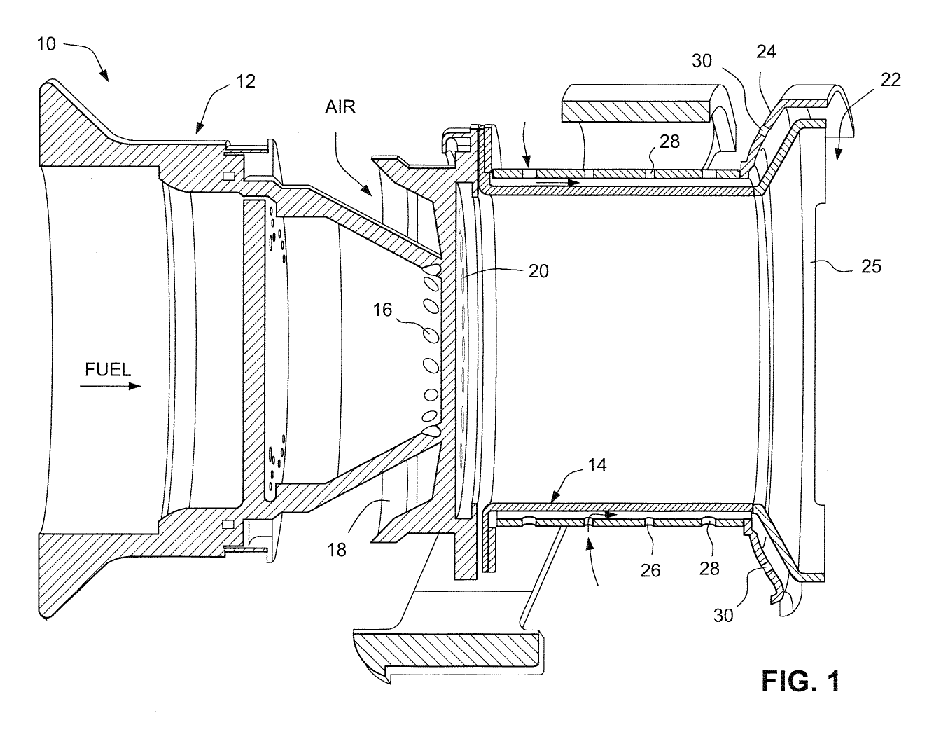

FIG. 1 illustrates the aft end of a turbomachine fuel nozzle 10 including the nozzle head 12 and an attached burner tube 14. The nozzle head 12 has a conical outlet end that supplies fuel via apertures 16 to be mixed with air entering a swirler or other mixing device 18 and exiting via circumferential slots 20. The fuel exiting the apertures 16 of the nozzle head mixes with the swirling air exiting slots 20 in the larger-diameter in the burner tube 14 before entering the combustion chamber 22, downstream of an impingement plate 24 and splash plate 25. In the conventional arrangement illustrated, the burner tube is surrounded by an impingement sleeve 26 radially spaced from the burner tube. The impingement sleeve is provided with circumferentially-arrayed apertures 28 by which compressor discharge air is allowed to flow through the apertures to thereby impingement cool the exterior surface of the burner tube 14. The air then flows along the burner tube and may be routed to exit at the aft end of the burner tube to join with air being supplied to the combustion chamber 22 via apertures 30 impinging on the splash plate 25.

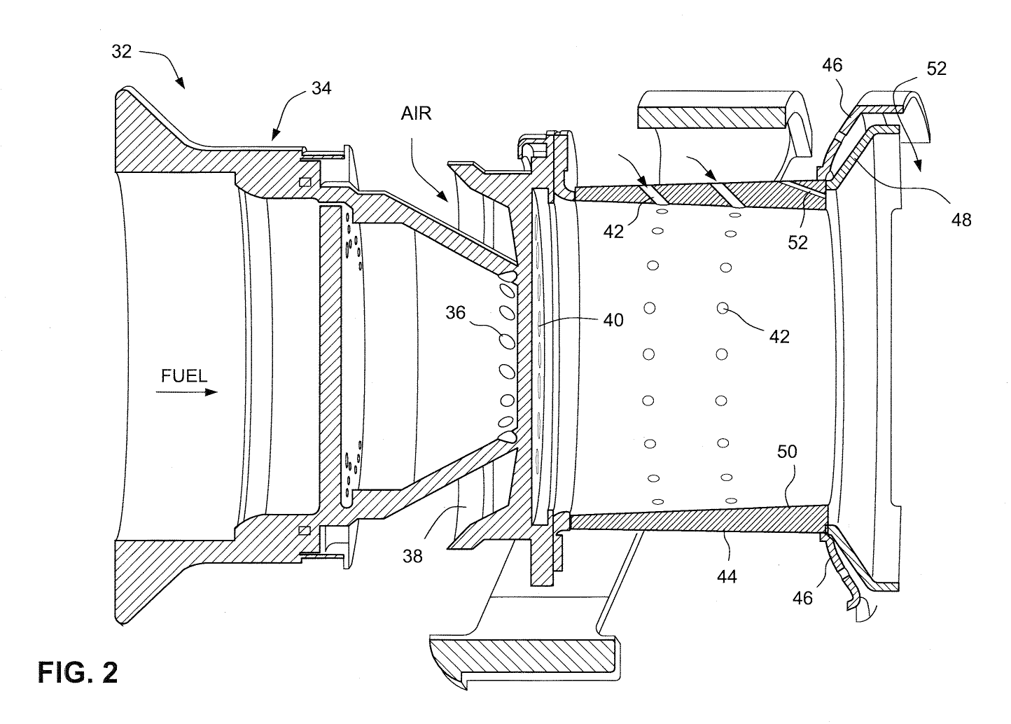

FIG. 2 illustrates a fuel nozzle 32 including a nozzle head 34 and burner tube 44 in accordance with an exemplary but nonlimiting embodiment of the invention. The nozzle head 34, fuel apertures 36, and swirler 38 and swirler holes or apertures 40 are similar to the corresponding components as described in connection with FIG. 1. Here, however, the impingement sleeve 26 utilized to cool the burner tube 14 is omitted.

Instead, plural holes, e.g., effusion cooling holes are formed directly in the burner tube 44 such that cooling air flows directly into the burner tube to mix with the fuel/air mixture from the nozzle head 34 and swirler 38. At the downstream end of the burner tube 44, both the impingement plate 46 and splash plate 48 are now fixed to the aft end of the burner tube 44.

The effusion cooling holes 42 are preferably slanted in an axial direction, e.g., at an angle of between 30-60°, so that the effusion cooling air tends to flow along the inside of the burner tube 44 to thereby cool the hot side of the burner tube and, at the same time, keep the fuel away from the burner tube wall. The effusion cooling air thus enters directly into the burner tube but in part-axial direction so that air remains close to the burner tube surface as it travels at higher velocity axially along the length of the tube.

The cooling holes 42 may also be slanted in one or the other of counterclockwise and clockwise, circumferential directions to cause the cooling air to swirl as it enters the burner tube 44, either swirling with or counter to, the swirling air/fuel mixture.

Two circumferential, axially-spaced rows of apertures or holes 42 are shown, but it will be appreciated that the number, diameter and pattern of the holes may vary. In one example, the cooling holes may have diameters in the range of from about 0.020 to about 0.060 in. In addition, the burner tube itself is formed with a slight conical shape, via tapered interior surface 50 with the narrower end located at the aft end of the burner tube, thereby increasing velocity and improving mixing as the mixture moves from left to right and into the combustion chamber 52.

Now that an aft row of cooling holes 52 adjacent the splash plate 48 are slanted at a more acute angle (15°-30°) relative to cooling holes 42, thereby directing some portion of the effusion cooling air in a more axial direction at the aft end of the burner tube, thus also providing some cooling to the splash plate 48.

Other benefits not already mentioned include increased durability of the burner tube and nozzle head or tip; reduced soot formation on startup; better flame holding margin and reduced emissions.

The cooling arrangement as described herein may be beneficially employed with various nozzle types including standard combustor nozzles, diffusion nozzles, DLN, combustor nozzles, primary nozzles, syngas nozzles and the like.

It will be appreciated that in the event the cooling air maintains the burner tube temperature constant, i.e., prevents overheating, it may be more appropriate to state that the burner tube is “treated” with air or other fluid rather than “cooled”.

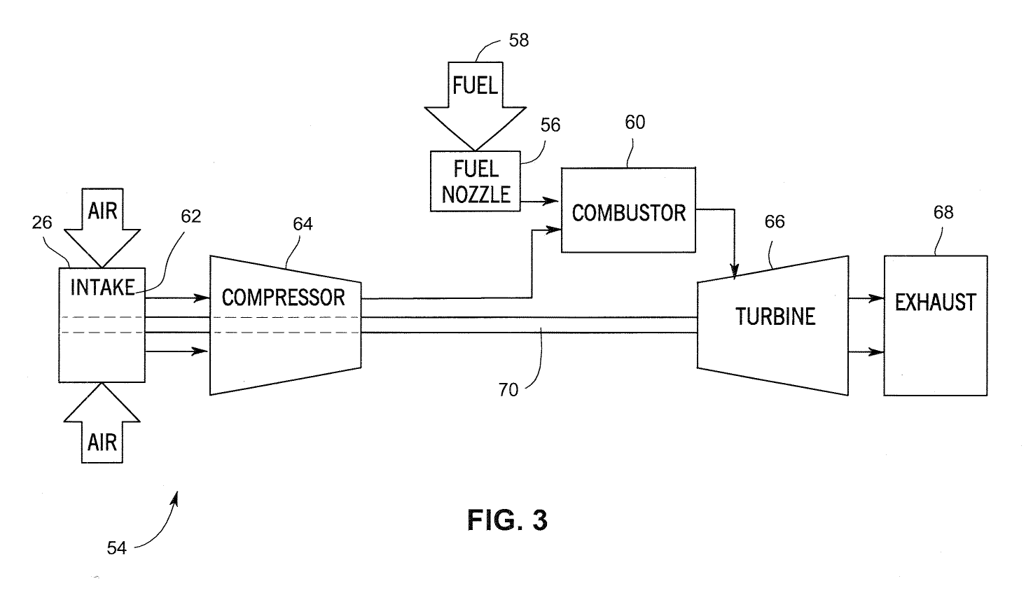

FIG. 3 illustrates a gas turbine 54 incorporating a fuel nozzle 56 as described hereinabove in connection with FIG. 2. The fuel nozzle 56 is supplied with fuel (indicated at 58) for combustion within a combustor 60. Air is supplied to the combustor 60 via air intake 62 and compressor 64. The gaseous products of combustion are directed to the turbine section 66 and subsequently to the turbine exhaust 68. In the illustrated embodiment, the turbine rotor 70 driven by the combustion gases also drives the compressor 64. It will be understood that the illustrated gas turbine configuration is merely exemplary of various turbine configurations in which one or more fuel nozzles 56 may be incorporated.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A fuel nozzle for a combustor comprising:
a nozzle head configured to supply a fuel/air mixture to a burner tube attached to said nozzle head and extending downstream of said nozzle head; said burner tube provided with plural holes for introducing a fluid into said burner tube to thereby treat an interior wall of said burner tube by effusion.

2. The fuel nozzle of claim 1 wherein said plural holes are slanted in a downstream direction.

3. The fuel nozzle of claim 1 wherein said plural holes are arranged in plural, axially-spaced, circumferentially extending rows about said burner tube.

4. The fuel nozzle of claim 1 wherein said plural holes are slanted in a circumferential direction.

5. The fuel nozzle of claim 1 wherein said plural holes have diameters between about 0.020 and about 0.060 inch.

6. The fuel nozzle of claim 1 wherein said burner tube is conically shaped, an inside diameter thereof decreasing in a downstream direction.

7. The fuel nozzle of claim 6 wherein said nozzle head is conically shaped, an outlet end diameter thereof decreasing in a downstream direction.

8. The fuel nozzle of claim 1 wherein said nozzle head is conically shaped, an outlet end diameter thereof decreasing in a downstream direction.

9. The fuel nozzle of claim 7 wherein said nozzle head has an outlet end with a diameter smaller than an inside diameter of said burner tube.

10. The fuel nozzle of claim 9 wherein said outlet end of said nozzle head is formed with a plurality of fuel orifices in an annular array, and wherein a swirler surrounds said outlet end and is adapted to supply air to be mixed with fuel exiting said plurality of fuel orifices.

11. The fuel nozzle of claim 1 wherein said plural holes are arranged in plural, axially-spaced, circumferentially extending rows about said burner tube, said plural holes slanted in a downstream direction.

12. The fuel nozzle of claim 11 and further comprising an outwardly conical splash plate attached to an aft end of said burner tube, and wherein at least one row of said plural, axially-spaced, circumferentially extending rows plural holes adjacent said splash plate are slanted at a more acute angle than remaining ones of said plural, axially-spaced, circumferentially extending rows plural holes.

13. A nozzle for a gas turbine comprising:
a nozzle head formed with plural fuel orifices at an aft end; a burner tube attached to said aft end of said nozzle head and extending downstream of said plural fuel orifices; a swirler arranged about said aft end of said nozzle head, adapted to introduce air for mixing with fuel exiting said plural fuel orifices; said burner tube provided with plural cooling holes downstream of said swirler for introducing cooling air into said burner tube, wherein said plural cooling holes are arranged in axially-spaced, circumferentially extending rows about said burner tube, and slanted in a downstream direction.

14. The nozzle of claim 13 wherein said plural cooling holes are slanted in a circumferential direction.

15. The nozzle of claim 13 wherein said burner tube is conically shaped, an inside diameter decreasing in a downstream direction.

16. The nozzle of claim 13 wherein said nozzle head is conically shaped, an outlet end diameter decreasing in a downstream direction.

17. The nozzle of claim 13 wherein said nozzle head has an outlet end with a diameter smaller than an inside diameter of said burner tube.

18. The nozzle of claim 15 wherein said plural cooling holes are round or non-round in cross section.

19. A method of effusion treating a burner tube in a turbine combustor comprising:
a. locating a burner tube at an outlet end of a fuel nozzle, adapted to receive a fuel/air mixture;
b. providing plural holes about the burner tube and introducing a fluid into the burner tube through said plural holes; and
c. slanting the plural holes in a downstream direction at an angle sufficient to direct the fluid along an interior surface of the burner tube.

20. The method of claim 19 wherein said plural holes are slanted between 30 and 60 degrees relative to a centerline axis through the burner tube, and wherein said fluid comprises cooling air.
